(19) United States
(12) Patent Application Publication
(10) Pub. No.: US 2013/0276897 A1
(43) Pub. Date: Oct. 24, 2013

(54) METHOD FOR CONTROLLING AN ACTUATOR OR VALVE

(71) Applicant: Schaeffler Technologies AG & Co. KG, Herzogenaurach (DE)

(72) Inventor: Carsten Mohr, Buehlertal (DE)

(21) Appl. No.: 13/868,528

(22) Filed: Apr. 23, 2013

Related U.S. Application Data
(63) Continuation of application No. PCT/DE2011/001786, filed on Sep. 29, 2011.

(30) Foreign Application Priority Data
Oct. 28, 2010 (DE) 102010049925.0

(51) Int. Cl. F16K 99/00

(52) U.S. Cl. CPC F16K 99/00
USPC 137/1

(57) ABSTRACT

A method for regulating an actuator or valve, wherein to execute a regulating function of the actuator or a valve function of the valve an actuating pulse is used, which is fed to the actuator or valve, characterized in that between at least two consecutive actuating pulses at least one additional pulse or a stochastic signal is fed to the actuator or valve.

### CROSS-REFERENCE TO RELATED APPLICATIONS

This application is filed under 35 U.S.C. §120 and §365(c) as a continuation of International Patent Application No. PCT/DE2011/001786 filed Sep. 29, 2011, which application claims priority from German Patent Application No. 10 2010 049 925.0 filed Oct. 28, 2010, which applications are incorporated herein by reference in their entireties.

### FIELD OF THE INVENTION

The invention relates to a method for controlling an actuator or valve.

### BACKGROUND OF THE INVENTION

DE 195 40 099 A1 discloses a system for active noise reduction.

Due to their continuous motion, switching actuators or valves often produce structure-borne noise vibrations or sounds, which are either emitted directly as airborne noise or are transmitted via the adjacent structure as structure-borne noise and emitted audibly at a different location as disturbing noise pulses. The annoyance of these noises is often caused by the temporal structure of these signals, and less by the loudness or actual energy content. To take an example from everyday experience, one could mention the sound of a dripping water faucet or the clicking of an automobile turn signal, which are conspicuous because of their pulsation, not their volume.

In terms of energy, the conspicuous ticking sound of regulating valves or injector valves extends across a broad frequency range, because of the pulsation of the signals.

Accordingly, remedial measures turn out in most cases to be quite expensive, since they too must be effective across a broad frequency range.

In order to improve for example the sound quality of direct-injection gasoline or diesel engines, encapsulating measures are most often employed; in which absorptive-clad hard-shell encapsulations cover the sound-emitting surfaces more or less completely.

Such acoustic capsules incur additional costs and unwanted weight increases. In terms of construction space as well, such coverings are often accepted only as a necessary evil.

In the case of the exposed installation position of new-type injection pumps above the engine valve cover, an encapsulation measure appears relatively ill-suited, since the necessary construction space is normally not available between the cylinder head cover (valve cover) and the hood.

For reasons of efficiency, regulating or injector valves are being operated at ever shorter clock rates—with correspondingly steep signal flanks—and shorter individual pulses. This gives rise to sound pulses with considerable time fluctuation, which stand out unpleasantly from the background noise of the running combustion engine and are perceived as correspondingly unpleasant.

### BRIEF SUMMARY OF THE INVENTION

The object of the invention is to improve the sound behavior of such components.

It provides for the conspicuousness of the sound pulses to be reduced. The “disturbance characteristic” of the sound—namely the time structure in the form of pulsation—is modified, thus greatly reducing the conspicuousness of the sound.

### DETAILED DESCRIPTION OF THE INVENTION

The method according to the invention provides for controlling an actuator or valve, wherein an actuating pulse is used to execute a regulating function of the actuator or a valve function of the valve. This pulse is fed to the actuator or valve. The invention provides that between at least two consecutive actuating pulses at least one additional pulse or a stochastic signal is fed to the actuator or valve, where, in the case of an actuator, the at least one additional pulse or the stochastic signal acts neutrally in terms of regulating function in reference to the actuator and neutrally in terms of valve function in reference to the valve in the case of a valve, but causes a sound from the actuator or valve.

Valve function means for example the opening or closing of a valve.

Neutral in terms of regulating function in reference to the actuator means that no regulating function is executed.

Neutral in terms of valve function in reference to the valve means that no valve function is executed.

In a preferred embodiment, the actuating pulse and/or the at least one additional pulse and/or the stochastic signal are electric or hydraulic.

In another preferred embodiment, the amplitude of the at least one additional pulse and/or of the stochastic signal is smaller than the amplitude of the actuating pulse.

In another preferred embodiment, the stochastic signal is bandpass-filtered, so that its frequency range is limited.

Additional advantages and advantageous configurations of the invention are the subject of the following description.

The invention provides for the time structure of the disturbing sounds to be changed by overlaying a continuous background sound, or one that is considered to be continuous, to the effect that in sum an unvarying sound without conspicuous individual sound pulses is perceived, and is thus seen as less conspicuous and less irritating.

In the particular case of a regulating valve of an injector pump, this regulating valve, because of its function, must periodically receive a brief single pulse, which results in a likewise periodic and acoustically conspicuous single sound pulse.

The invention provides, in the time segments between these pulse energizations, that an energization with a stochastic signal be executed—bandpass-limited, if necessary—such as for example background noise. This individual sound pulse which occurs due to the pulse energization is thereby overlaid with a sort of sound carpet, which results in the perception of a more continuous noise. It is known from extensive psychoacoustic investigations, that the acoustic conspicuousness and the sense of unpleasantness are significantly reduced thereby.

In this respect, such overlaying with a continuous, stochastic energization, which naturally must be carried out in such a way that there is no impairment of the actual regulating function, represents a measure for improving the sound behavior of such units.

The regulating valves which cause the noise are energized by means of a continuous stochastic sound signal, the amplitude of which is chosen such that it does not result in any impairment of the actual regulating function. According to the invention, the frequency range of the sound signal can be limited—for example by means of upstream bandpass-filtering—so that it can thereby be tuned optimally to the structural dynamic properties of the adjacent sound-emitting surfaces. For example, this would enable sufficient allowance to be made for resonance effects of the structure, which ensures a minimal expenditure of energy for the background noise.

For efficiency reasons, regulating or injector valves are being operated at ever shorter clock rates (with correspondingly steep signal flanks) and shorter individual pulses. This gives rise to sound pulses with considerable time fluctuation, which stand out unpleasantly from the background noise of a running combustion engine and are perceived as correspondingly unpleasant.

The unpleasantness of these sounds is caused by the temporal structure of these signals, which is why this structure must be modified to improve the sound quality.

To take an example from everyday experience, one could mention the sound of a dripping water faucet or the clicking of an automobile turn signal, which are conspicuous because of their pulsation, not their volume.

Energizing with a continuous sound signal, whose amplitude and frequency content can be appropriately matched to the structural dynamic situation, produces a continuous background noise, so that in sum an unvarying sound without noticeable individual sound pulses is perceived, and is thus considered to be less conspicuous and less irritating.

What is claimed is:

1. A method for regulating an actuator or valve, comprising the steps of:
transmitting a series of actuating pulses to the actuator or valve; and,
transmitting an additional pulse or a stochastic signal to said actuator or valve between at least two of said actuating pulses, wherein said additional pulse or said stochastic signal acts neutrally in terms of regulating function with respect to the actuator, and wherein said additional pulse acts neutrally in terms of valve function with respect to the valve, and wherein said additional pulse causes a sound to be emitted from the actuator or valve.

2. The method recited in claim 1, wherein the actuating pulse and/or the at least one additional pulse and/or the stochastic signal are electric or hydraulic.

3. The method recited in claim 1, wherein the amplitude of the at least one additional pulse and/or of the stochastic signal is less than the amplitude of the actuating pulse.

4. The method recited in claim 1, wherein the stochastic signal is bandpass-filtered so that its frequency range is limited.
